(19) United States
(12) Patent Application Publication
(10) Pub. No.: US 2008/0159448 A1
(43) Pub. Date: Jul. 3, 2008

(54) System and method for crosstalk cancellation

(75) Inventors: Kofi Dankwa Anim-Appiah, Allen, TX (US); Nirmal C. Warke, Irving, TX (US)

Correspondence Address: TEXAS INSTRUMENTS INCORPORATED, P O BOX 655474, M/S 3999, DALLAS, TX, 75265, US

(73) Assignee: Texas Instruments, Incorporated

(21) Appl. No.: 11/647,993

(22) Filed: Dec. 29, 2006

(51) Int. Cl. H04B 1/10

(52) U.S. Cl. 375/346; 455/65; 375/231

(57) ABSTRACT

System and method for canceling crosstalk in high-speed communications systems. An embodiment comprises precomputing channel pulse responses for a set of communications channels in a communications backplane, precomputing channel signal responses for the set of communications channels in the backplane with a training sequence, estimating noise coefficients using receiver training and the training sequence, storing noise coefficients for each communications channel in the set of communications channels, and canceling noise in a received transmission of a data sequence using the stored noise coefficients. The regularity of the communications backplane enables the precomputing of various values, which reduces computational requirements. Furthermore, it is often the case that a victim receiver has access to the digital data that is being transmitted by its dominant crosstalking transmitters, thereby simplifying noise cancellation.

### TECHNICAL FIELD

The present invention relates generally to a system and method for high-speed digital communications, and more particularly to a system and method for canceling crosstalk in high-speed communications systems.

### BACKGROUND

As the transmission rates of communications networks continue to increase, crosstalk has become an increasingly important limiting factor to the transmission rates. Crosstalk occurs when a signal transmitted on one communications channel of a communications network is corrupted by interference from another signal transmitted by another communications channel. Crosstalk has become more significant since as the transmission rates increase, the communications channels become better antennas, that is, better at transmitting interference and better at receiving interference.

Interference from a first communications channel, referred to as the crosstalking channel, is received by a second communications channel, referred to as the victim channel. The interference received by the victim channel raises the noise floor of the victim channel and can make the decoding of the signal carried on the victim channel at a victim receiver more error prone, thereby reducing the transfer rate of the victim channel.

A serializer/deserializer (serdes) is a device used for routing high-speed data (e.g., data rates in excess of 6 Gbps) on backplanes with a low bit error rate (BER) (e.g., less than 10⁻¹⁵). Each application specific integrated circuit (ASIC) device typically incorporates a large number of high-speed serdes that may operate concurrently on a backplane. A typical backplane is made up of thousands of individual channels (serial links), with individual channels realized as copper traces on a large multilayer printed circuit board. The ASICs containing the serdes' are normally mounted on smaller printed circuit boards that may be inserted into and removed from the backplane via a set of mating connectors.

Due to crosstalk, the dense network of communications channels present on a backplane may be an impediment to achieving low BER. A victim receiver may simultaneously receive a signal intended for it from its corresponding transmitter, as well as additional unwanted noise from neighboring transmitters. As the signaling rates on the backplane increase, the effects of crosstalk becomes more pernicious, since coupling between adjacent communications channels increases with frequency, both through the signal traces and the connectors on the backplane used to connect the circuit boards (with the ASICs) to the backplane.

### SUMMARY OF THE INVENTION

These and other problems are generally solved or circumvented, and technical advantages are generally achieved, by embodiments of the present invention which provide a system and a method for canceling crosstalk in high-speed communications systems.

In accordance with an embodiment, a method for noise cancellation at a receiver in a communications backplane is provided. The method includes precomputing channel pulse responses for a set of communications channels in the communications backplane, precomputing channel signal responses for the set of communications channels in the backplane with a training sequence, and estimating noise coefficients using receiver training and the training sequence. The method also includes storing noise coefficients for each communications channel in the set of communications channels, and canceling noise in a received transmission of a data sequence using the stored noise coefficients.

In accordance with another embodiment, a noise cancellation training system is provided. The noise cancellation system includes a receiver in a communications backplane, the receiver including an analog-to-digital converter coupled to a signal input, the analog-to-digital converter to digitize a signal provided at the signal input, and a clock/data recovery unit coupled to the analog-to-digital converter, the clock/data recovery unit to provide a timing signal to drive the analog-to-digital converter. The noise cancellation system also includes a memory coupled to the receiver, the memory to store the digitized signal, and a metric unit coupled to the memory, the metric unit to compute a difference metric between the digitized signal and a plurality of communications channel responses to a known data sequence.

In accordance with another embodiment, a noise cancellation training system is provided. The noise cancellation system includes a memory to store a plurality of communications channel responses to a known data sequence, a digital-to-analog converter coupled to the memory, an adder coupled to the digital-to-analog converter and to a signal input, an energy detector coupled to an output of the adder, and a control logic unit coupled to the energy detector and the memory. The digital-to-analog converter converts coefficients of the communications channel response into an analog equivalent, the adder subtracts an analog version of a communications channel response to the known data sequence from a signal provided at the signal input, and the energy detector computes an average energy in the output of the adder. The control logic unit selects a communications channel response to the known data sequence to provide to the digital-to-analog converter.

An advantage of an embodiment is that only a relatively small amount of computational power is required. Therefore, the crosstalk cancellation can occur dynamically without requiring a significant investment in processing capability.

A further advantage of an embodiment is that it may be applicable to a wide range of different backplane designs and is not for use only on a single backplane design. The greater flexibility may enhance the acceptance and accelerate deployment.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIGS. 1a and 1b are diagrams of an exemplary serdes and an exemplary communications backplane;

FIG. 2 is a diagram of a receiver training system;

FIG. 3 is a diagram of a receiver training system;

FIG. 4 is a diagram of a noise elimination system;

FIG. 5 is a flow diagram of a noise cancellation algorithm; and

FIGS. 6a through 6c are flow diagrams of receiver training algorithms.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a backplane containing a number of serdes' used in high-speed data transmissions. The invention may also be applied, however, to other applications wherein there is a consistent hardware design that is replicated a number of times and where there is a desire to reduce crosstalk.

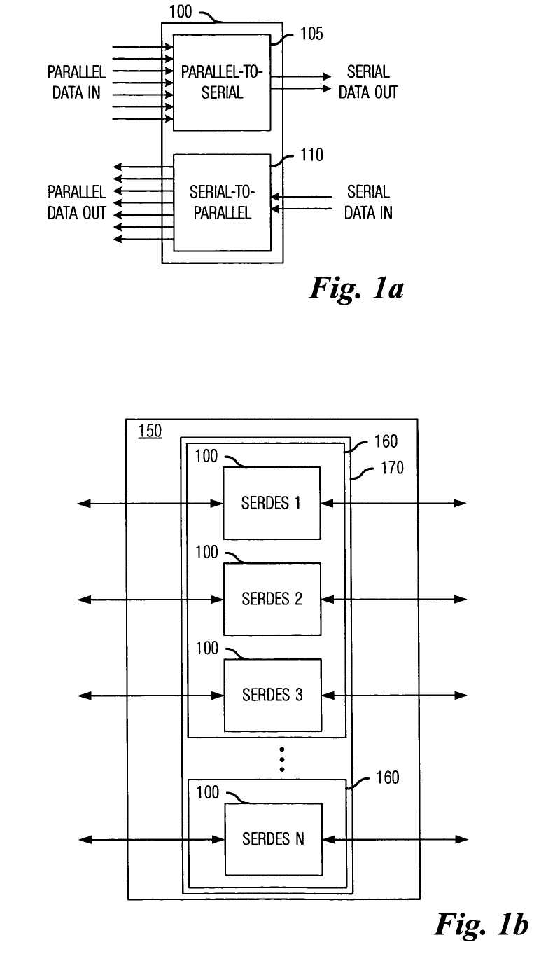

With reference now to FIG. 1a, there is shown a diagram illustrating a high-level view of a serdes 100. The serdes 100 includes a parallel-to-serial converter 105, which may be used to convert received parallel data into outgoing serial data. The serdes 100 also includes a serial-to-parallel converter 110, which may be used to convert received serial data into outgoing parallel data.

As discussed previously, the serdes 100 may be located on a printed circuit board, which may be connected to a backplane. A diagram shown in FIG. 1b illustrates a high-level view of a backplane 150 containing N serdes'. Each of the N serdes 100 may be integrated into one or more ASICs 160. The ASICs 160 may be mounted on a printed circuit board 170 that is connected to the backplane 150 by a connector, which in turn, allows the serdes 100 located on the ASIC 160 to connect to a plurality of incoming and outgoing communications channels.

The large number of serdes' 100 and communications channels on the backplane 150, along with the high data transfer rates, make the backplane 150 a very electrically noisy environment. Interference from signals transmitted on communications channels can reduce the data transfer rates of the serdes' 100 by increasing the noise floor and the BER.

Serdes deployment on backplanes may have some properties that may encourage certain aspects of crosstalk cancellation. Most notable of these properties may be that a given backplane design may be replicated very closely in all deployments, subject chiefly to manufacturing tolerances which can be very tight due to the manner in which the circuit boards are manufactured. Therefore, a given channel and its crosstalking channels may be virtually identical in all deployments of that backplane. Although there may be a large number of crosstalking channels for a given receiver, the most significant crosstalking channels (dominant crosstalking channels) are usually associated with adjacent transmitters on the same serdes device, ASIC, or located near the ASIC. Therefore, it often may be the case that a victim receiver has access to the digital data that is being transmitted by its dominant crosstalking transmitters. This may simplify crosstalk cancellation.

Effective cancellation of a given crosstalking transmitter in a serdes device will typically require knowledge of T-spaced samples, taken at the proper phase, of a symbol response of the crosstalking channel, where T is the baud duration. The symbol response of the crosstalking channel may be referred to as the crosstalking channel's channel pulse response. The victim receiver may be taking its samples at phase φᵥ, but this may not be necessarily the phase of the crosstalking symbol response that is seen by the victim receiver. This may be due to a probable difference in the propagation delays of the victim receiver and the crosstalking channels.

However, since the design of the backplane may be fixed, the symbol response of each of the dominant crosstalking transmitters for a given victim channel may be known, but the sampling phase of the victim receiver may not be known before the channel is in operation. Therefore, in order to obtain the proper T-spaced samples of a particular crosstalking channel, the victim receiver may need to estimate the relative phase, δ_{φ}, between its sampling clock and a transmit clock of the crosstalking transmitter. The estimation may be facilitated by receiver training.

With the knowledge of δ_{φ} and the symbol response of the crosstalking channel, the T-spaced samples at phase φ=(φᵥ+δ_{φ}) can be obtained. Combined with knowledge of the data being transmitted by the crosstalking channel, an estimate of the noise that it contributes to the victim receiver may be estimated and then subtracted from the victim receiver's signal at the sampling instant. This subtraction may be performed for each crosstalking transmitter for which noise cancellation may be desired.

For example, let an i^{th} crosstalking transmitter's data sequence be {dₖ⁽ⁱ⁾} at transmit clock phase φ⁽ⁱ⁾=φᵥ+δ_{φ}⁽ⁱ⁾ and the symbol response of the i^{th} crosstalking channel be p⁽ⁱ⁾(t). With binary non-return to zero (RZ) signaling, dₖ⁽ⁱ⁾ε{±1}, the T-spaced samples at phase φ⁽ⁱ⁾ may be defined as:

$${\{ {p}^{( i )} ( kT + {φ}^{( i )} ) \}}_{k = 0}^{k = {L}_{p} - 1} ≡ {\{ {p}_{k}^{( i )} \}}_{k = 0}^{k = {L}_{p} - 1} ,$$

where Lₚ is the length of the symbol response. The estimate of the noise from the i^{th} crosstalking transmitter in a j^{th} victim's sample may be expressible as:

$${n}_{j}^{( i )} = {\sum }_{k = 0}^{{L}_{p} - 1} {p}_{k}^{( i )} {d}_{j - k}^{( i )} .$$

Therefore, if the j^{th} noisy sample of the received victim's signal is rⱼ, then, for N crosstalking transmitters, the crosstalk-cancelled signal yⱼ may be expressed as:

$${y}_{j} = {r}_{j} - {\sum }_{i = 1}^{N} {n}_{j}^{( i )} .$$

### However, due to the high data transfer rates of the communications channels of the backplanes, a low-complexity implementation may be desired to help ensure that the crosstalk cancellation may occur in real-time.

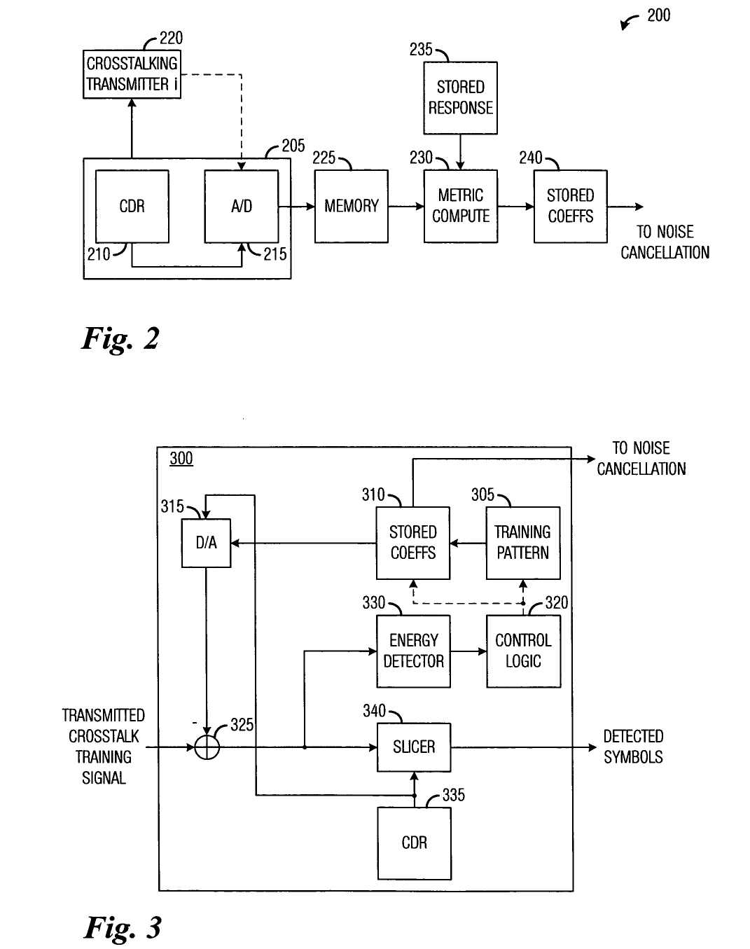

With reference now to FIG. 2, there is shown a diagram illustrating a high-level view of a receiver training system 200 for use in crosstalk elimination. Receiver training may be used to estimate the T-spaced symbol response for each crosstalking transmitter. This training may take place during an initialization period shortly after a particular serdes device is inserted into the backplane. Alternatively, the training may take place during manufacture of the serdes and/or the backplane. This may be possible since the design of the serdes and/or the backplane is substantially constant across a wide range of implementations.

The receiver training system 200 includes a victim receiver 205, which may include a clock/data recovery unit (CDR) 210 and an analog-to-digital converter (A/D) 215. The CDR 210 may be responsible for generating control timing information to control the operation of the A/D 215, among other functions. Also shown in FIG. 2 is a crosstalking transmitter i 220, which may be one of many crosstalking transmitters affecting the victim receiver 205. The diagram also illustrates a memory 225, a metric compute unit 230, a stored response unit 235, and a stored coefficients unit 240. In practice, the stored response unit 235 and the stored coefficients unit 240 may be implemented as storage space in the memory 225.

The victim receiver 205 may issue a transmission start command to the crosstalking transmitter i 220. The crosstalking transmitter i 220 may then transmit a known training sequence, B⁽ⁱ⁾(t), which may be detected by the victim receiver 205. The AID 215 of the victim receiver 205 may then convert the detected training sequence into a digital representation, Bₖ⁽ⁱ⁾. The digitized detected training sequence from crosstalking transmitter i 220 may then be stored in the memory 225. The victim receiver 205 may repeat the process for one, two, three or more or all remaining crosstalking transmitters.

In an effort to minimize the required computations and potentially circumvent the need to estimate the phase offsets φ⁽ⁱ⁾ and then subsequently the T-spaced symbol response, the T-space symbol responses for a number of M different phases of each crosstalking channel pulse response may be precomputed and stored in the serdes device (in the stored response unit 235, for example). The phases may be uniformly distributed over an entire baud duration with an offset δ=T/M. Therefore, for the crosstalking transmitter i 220, the phases may be expressed as:

{p⁽ⁱ⁾(kT+mι_{φ}}ₖ₌₀^{L}^{ₚ}⁻¹={pₖ⁽ⁱ⁾(m)}m=0,1,2, . . . M−1.

For example, for M=4, the four phase sequences (channel pulse responses) may be expressed as:

{p⁽ⁱ⁾(kT)}=p⁽ⁱ⁾(0), p⁽ⁱ⁾(T), p⁽ⁱ⁾(2T), . . . , p⁽ⁱ⁾((Lₚ−1)T),

{p⁽ⁱ⁾(kT+δ_{φ})}=p⁽ⁱ⁾(δ_{φ}), p⁽ⁱ⁾(T+δ_{φ}),p⁽ⁱ⁾(2T+δ_{φ}), . . . , p⁽ⁱ⁾((Lₚ−1)T+δ_{φ}),

{p⁽ⁱ⁾(kT+2δ_{φ})}=p⁽ⁱ⁾(2δ_{φ}), p⁽ⁱ⁾(T+2δ_{φ}), p⁽ⁱ⁾(2T+2δ_{φ}), . . . , p⁽ⁱ⁾((Lₚ−1)T+2δ_{φ}),

{p⁽ⁱ⁾(kT+3δ_{φ})}=p⁽ⁱ⁾(3δ_{φ}), p⁽ⁱ⁾(T+3δ_{φ}), p⁽ⁱ⁾(2T+3δ_{φ}), . . . , p⁽ⁱ⁾((Lₚ−1)T+3δ_{φ}).

In practice, only a few terms of each phase sequence may be necessary for effective crosstalk elimination, for example, five terms. Furthermore, a relatively small number of phase sequences (M) is sufficient, for example, M=8. Reducing the number of terms in each phase sequence and the number of phase sequences may yield a significant reduction in the memory requirement, such as the memory 225.

Alternatively, the T-spaced symbol responses for a number of M different phases of each crosstalking transmitter may be determined (computed) by the manufacturer of the backplane communications system or the serdes ASIC and stored in a memory. Again, this is possible due to the regularity of the backplane communications system designs. Having the different phases of the T-spaced symbol responses for each crosstalking transmitter already stored in memory may help to simplify the initial configuration and setup of the backplane communications system.

Also precomputed and stored may be the output of each T-spaced response when excited by the training sequence, referred to as channel signal responses. These precomputed values may be stored in the stored response unit 235. Let {Iₖ}ₖ₌₀^{k=L}^{_{I}}⁻¹ be the training sequence of length L_{I}. Then, for the m^{th} phase of the i^{th} crosstalking transmitter, the precomputed T-spaced response when excited by the training sequence may be expressed as:

$${\{ {A}_{k}^{( i )} ( m ) \}}_{k = 0}^{k = {L}_{I} + {L}_{p}} = \{ {\sum }_{j = 0}^{{L}_{p} - 1} {p}_{j}^{( i )} ( m ) {I}_{k - j} \} .$$

The training sequence, {Iₖ}ₖ₌₀^{k=L}^{_{I}}⁻¹, may be any pseudo-random sequence. In practice, a truncated version of any well-known pseudo-random sequence, such as PRBS7, may be used.

Alternatively, due to the regularity of the backplane communications system designs, and if combined with a preset training sequence, it is possible for the manufacturer to precompute the channel signal responses and store them in a memory. The manufacturer may be able to perform the precomputations during the manufacture of the backplane communications system and store the responses in memory prior to shipping the product to the customer. This can help to simplify the configuration and installation of the backplane communications system. The precomputing of the channel pulse response and the channel signal response by the manufacturer may preclude some flexibility on the user of the backplane communications systems, for example, this may prevent the user from selecting their own training sequence.

After the victim receiver 205 receives the transmission from the crosstalking transmitter i 220 and digitizes it (via the A/D 215), a comparison between the digitized received transmission {Bₖ⁽ⁱ⁾} and the stored precomputed values {Aₖ⁽ⁱ⁾} may be made in the metric compute unit 230. The metric compute unit 230 may compute a minimum squared Euclidean distance between the two sets of values, for example. The minimum squared Euclidean distance may be expressed as:

$$M {1}^{( i )} ( m ) = {\sum }_{k = 1}^{{L}_{I} + {L}_{p}} {( {A}_{k}^{( i )} ( m ) - {B}_{k}^{( i )} )}^{2} .$$

### The metric compute unit 230 may compute the minimum squared Euclidean distance using each of the stored precomputed values {Aₖ⁽ⁱ⁾}.

To help reduce the computational requirements associated with the squaring in the computation of the minimum squared Euclidean distance equation above, an alternative computation, such as a Lee distance-like metric, for which the phase that minimizes the quantity expressible as:

$$M {2}^{( i )} ( m ) = {\sum }_{k = 1}^{{L}_{I} + {L}_{p}} \vert {A}_{k}^{( i )} ( m ) - {B}_{k}^{( i )} \vert ,$$

may be preferred.

Therefore, if mₘᵢₙ⁽ⁱ⁾ minimizes M2⁽ⁱ⁾(m) or M1⁽ⁱ⁾(m), then the victim receiver 205 may select {pₖ⁽ⁱ⁾(mₘᵢₙ⁽ⁱ⁾)} as the crosstalk canceling coefficients (also referred to as the crosstalk noise estimates), which may then be stored in the stored coefficients unit 240. The stored crosstalk canceling coefficients for each of the crosstalking transmitters may be stored in the stored coefficients unit 240 and be provided to a noise cancellation unit for use during normal operations. A discussion of the noise cancellation unit is provided below.

As discussed above, it may be possible for the manufacturer of the backplane communications system to compute the channel pulse response and/or the channel signal response and store the coefficients in memory. It may also be possible for the manufacturer to determine the phase of the channel pulse response and/or the channel signal response that will minimize the difference metric, such as the distance metric computed in the metric compute unit 230. If the manufacturer can determine the proper phase, then it may be possible to eliminate the need to store the channel pulse response and/or the channel signal response, thereby reducing the memory storage requirements.

Some of the components displayed in FIG. 2, such as the memory 225, the metric compute unit 230, the stored response unit 235, and the stored coefficients unit 240 may be shared by the different victim receivers of a single serdes device, a single ASIC, a single printed circuit board, or of a single backplane. Such a configuration may result in a significant savings in the computational and storage requirements for each victim receiver. Alternatively, each victim receiver may include these components. While potentially increasing the computational and storage requirements, providing each victim receiver with is own set of the components can expedite the configuration of the crosstalk cancellation by permitting some of the operations to occur in parallel.

With reference now to FIG. 3, there is shown a diagram illustrating a high-level view of a receiver training system 300 for use in crosstalk elimination. The receiver training system 300 may be entirely contained within a victim receiver. The receiver training system 300 includes a training pattern unit 305 that contains a locally stored copy of a training sequence used in the receiver training. The receiver training system 300 also includes a stored coefficients unit 310 that may be used to store the crosstalk canceling coefficients {pₖ⁽ⁱ⁾(m⁽ⁱ⁾)} for various crosstalking transmitters i for each of the different m phases. The crosstalk canceling coefficients may also be referred to as the crosstalk noise estimates.

The receiver training system 300 (a victim receiver) may signal to a crosstalking transmitter i to begin its transmission of the training sequence. The transmitted crosstalk training sequence may then be received at an input of the receiver training system 300, which can subtract an analog version of a stored crosstalk noise signal (which may be a convolution of the stored crosstalk canceling coefficients and the crosstalk training sequence) that has been converted by a digital-to-analog converter (D/A) 315. The receiver training system 300 includes a control logic unit 320 that can select a stored crosstalk canceling coefficient from the stored coefficients unit 310 for determination of the crosstalk noise signal to provide to the D/A 315.

An adder 325 may then subtract the analog version of the crosstalk noise signal from the received crosstalk training signal, which may then be provided to an energy detector unit 330. The energy detector unit 330 may be an implementation of an average energy detector, whose output may be similar to the metric compute unit 230 of FIG. 2. The output of the energy detector unit 330 may be provided to the control logic unit 320. The control logic unit 320 may select each of the m sets of stored crosstalk canceling coefficients and, based on the output of the energy detector unit 330 for each of the m sets, select the set that minimizes the output of the energy detector unit 330. A clock/data recovery unit (CDR) 335 may generate a clock that drives the D/A 315. A slicer (sampler) 340 can sample the output of the adder 325 to produce symbols. The selected set of crosstalk canceling coefficients for each of the crosstalking transmitters may be stored in the stored coefficients unit 340 and be provided to a noise cancellation unit for use during normal operations. A discussion of the noise cancellation unit is provided below.

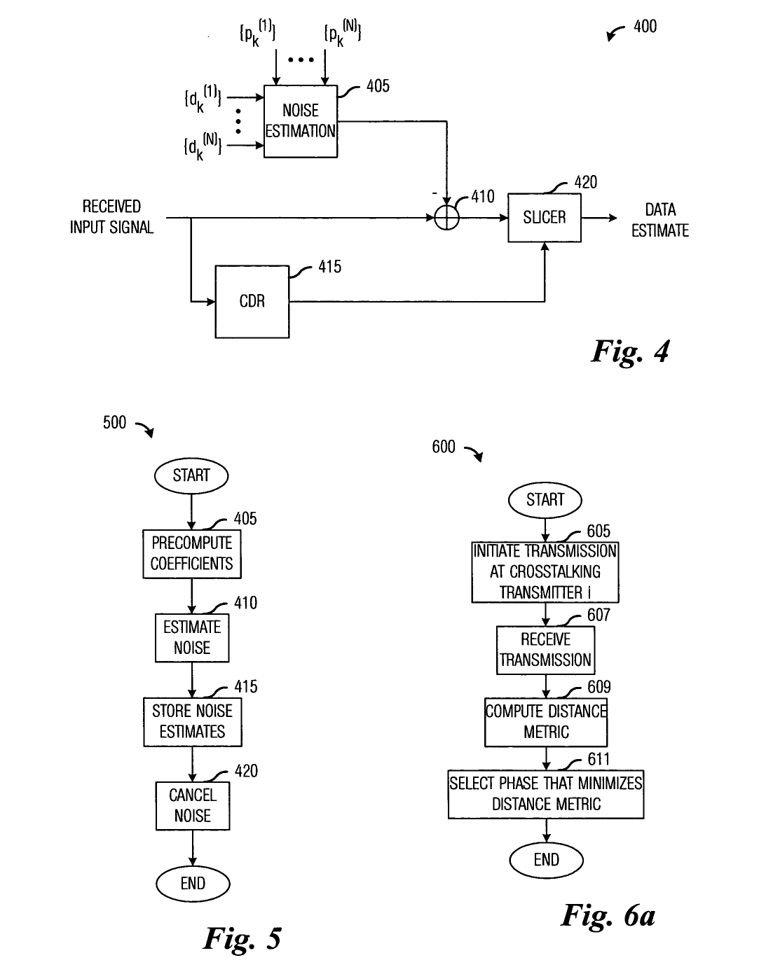

With reference now to FIG. 4, there is shown a diagram illustrating a noise cancellation unit 400. The noise cancellation unit 400 includes a noise estimation unit 405, which may have as input the selected stored coefficients for each of the N crosstalking transmitters, {pₖ⁽ⁱ⁾(m⁽ⁱ⁾)}, for a given victim receiver. Also input to the noise estimation unit 405 may be the data sequence transmitted by the N crosstalking transmitters, dₖ⁽ⁱ⁾. Since the dominant sources of crosstalking noise to a victim receiver are likely to be transmitters that are in close proximity to the victim receiver, the data sequences transmitted by the crosstalking transmitters may be readily available to the victim receiver for use in noise cancellation. The noise estimation unit 405 may make use of these inputs in the computation of a crosstalk noise estimate from the i^{th} crosstalking transmitter in the j^{th} victim receiver, which may be expressible as:

$${n}_{j}^{( i )} = {\sum }_{k = 0}^{{L}_{p} - 1} {p}_{k}^{( i )} {d}_{j - k}^{( i )} .$$

The crosstalk noise estimate, as produced by the noise estimation unit 405, may then be provided to an adder 410, which may subtract the crosstalk noise estimate from the received input signal to produce a cleaned received input signal, expressible as:

$${y}_{j} = {r}_{j} - {\sum }_{i = 1}^{N} {n}_{j}^{( i )} .$$

### A clock/data recovery unit (CDR) 415 may produce timing signals for a slicer 420, which may produce an estimate of the data received by the victim receiver.

With reference now to FIG. 5, there is shown a diagram illustrating an algorithm 500 for use in canceling crosstalk noise in a communications backplane. The algorithm 500 may execute in receivers on the backplane to cancel crosstalk noise from crosstalking transmitters that are also collocated on the backplane. The algorithm 500 may begin with each of the receivers on the backplane precomputing signals which may be T-spaced responses that are excited by a known training sequence (block 405). The precomputed signals, which may be computed for each crosstalking transmitter for the receiver, may be referred to as the channel pulse responses for the receiver. The receivers may store the T-spaced signal responses in a memory located in the receiver or in a shared memory. With the precomputed signals computed and stored, each receiver may estimate a channel signal response to a known training sequence from each of the crosstalking transmitters (block 410). The channel signal response may also be saved for later use (block 415). Once the channel signal response have been estimated by receiver training with known training sequences, the backplane may enter a normal operating mode where each receiver may cancel noise received at its input signal using the channel signal response ({pₖ⁽ⁱ⁾(m⁽ⁱ⁾)}) and knowledge of transmitted data sequences (dₖ⁽ⁱ⁾) (block 420).

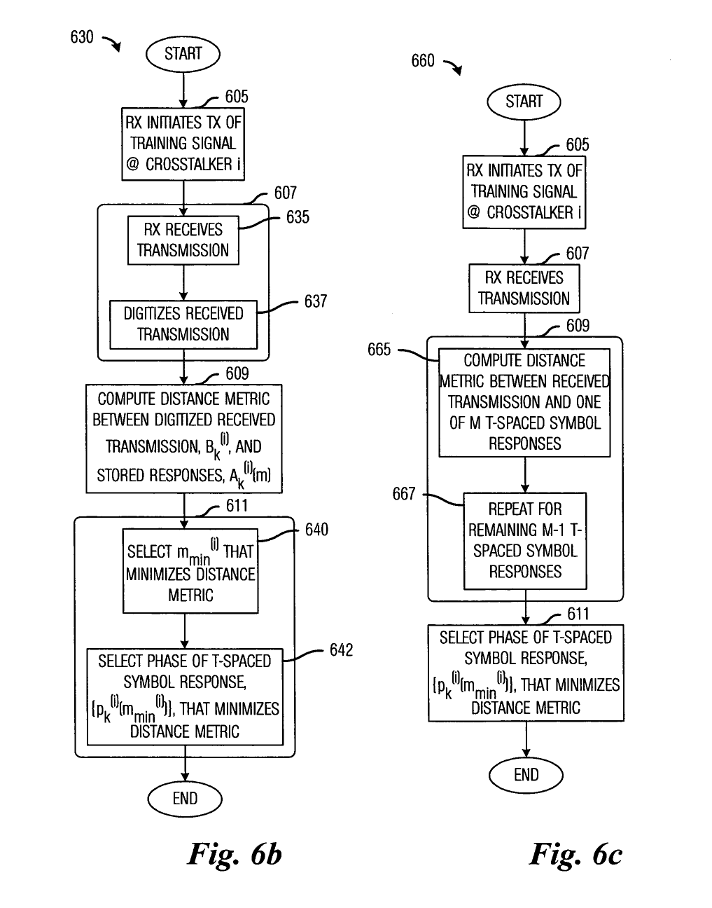

With reference now to FIGS. 6a through 6c, there are shown diagrams illustrating noise estimation algorithms using receiver training. The diagram shown in FIG. 6a illustrates a high-level view of a noise estimation algorithm 600 for use in canceling crosstalk noise in a communications backplane. The noise estimation algorithm 600 may be used in an implementation of the estimate noise block 410 of the canceling crosstalk noise algorithm 500 (FIG. 5).

The noise estimation algorithm 600 may begin with an initiation of a transmission of a known sequence by a crosstalking transmitter i (block 605). The transmission made by the crosstalking transmitter i may be received by a victim receiver (block 607). The victim receiver may then compute a distance metric, which may provide a measure of the distance (difference) from what was received at the victim receiver and what was expected at the victim receiver (block 609). Due to unknown phase differences, the distance metric may have to be computed at a variety of different phases. The victim receiver may then select the phase difference that results in the smallest distance metric as the phase for the crosstalking transmitter i (block 611). The victim receiver may repeat the initiation of the transmission of the known sequence from a number of crosstalking transmitters with each crosstalking transmitter potentially transmitting the same known sequence or a different sequence or a combination of both. The diagrams shown in FIGS. 6b and 6c illustrate detailed views of exemplary embodiments of the noise estimation algorithm 600 for the receiver training system 200 (algorithm 630) and the receiver training system 300 (algorithm 660).

As part of receiving the transmission made by the crosstalking transmitter i (block 607), the victim receiver using the receiving training system 200, as shown in FIG. 6b, may perform a two step process, including receiving the transmission (block 635) and then digitizing the received transmission (block 637). Furthermore, after computing a distance metric between the received transmission and the stored responses (block 609), the victim receiver may perform the selection of the phase difference resulting in the smallest distance between the received transmission and the stored responses (block 611) in two process steps. A first process step may include selecting an m that results in the minimum distance metric value (block 640) and a second process step may include selecting a phase of the T-spaced symbol responses that minimizes the minimum distance metric (block 642).

As part of computing a distance metric between the received transmission and the stored responses (block 609), the victim receiver using the receiver training system 300 may perform a two step process, as shown in FIG. 6c, including computing a distance metric between the received transmission and the computed signal based on one of the stored T-spaced symbol responses (block 665) and then repeating the computing (block 665) for the remaining M−1 T-spaced symbol responses (block 667).

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for noise cancellation at a receiver in a communications backplane, the method comprising:
precomputing channel pulse responses for a set of communications channels in the communications backplane;
precomputing channel signal responses for the set of communications channels in the backplane with a training sequence;
estimating noise coefficients using receiver training and the training sequence;
storing noise coefficients for each communications channel in the set of communications channels; and
canceling noise in a received transmission of a data sequence using the stored noise coefficients.

2. The method of claim 1, wherein the precomputing of the channel pulse response and the precomputing of the channel signal response is performed by a manufacturer of the communications backplane and stored in a memory.

3. The method of claim 1, wherein the precomputing of the channel pulse responses and the precomputing of the channel signal responses with the training sequence occurs during an initial configuration of the communications backplane.

4. The method of claim 3, wherein the precomputed channel pulse responses and the precomputed channel signal responses with the training sequence are stored in a memory.

5. The method of claim 1, wherein there are M channel pulse responses, and wherein the precomputing of the channel pulse responses comprises:
computing a channel pulse response; and
sampling the channel pulse response with a phase offset of T/M to create the M channel pulse responses, where T is a baud duration of the communications backplane.

6. The method of claim 1, wherein the estimating comprises:
initiating a transmission of the training sequence by a transmitter over a communications channel;
receiving the transmission at the receiver;
computing a difference metric between the received transmission and the precomputed channel signal responses with the training sequence associated with the transmitter; and
selecting a phase of the precomputed channel signal response with the training sequence that minimizes the difference metric.

7. The method of claim 6, wherein the difference metric comprises a Euclidean distance metric expressible as:
$${Metric}^{( i )} ( m ) = {\sum }_{k = 1}^{{L}_{I} + {L}_{p}} {( {A}_{k}^{( i )} ( m ) - {B}_{k}^{( i )} )}^{2} ,$$
where Aₖ⁽ⁱ⁾(m) is the k^{th} term of the precomputed channel signal response with the training sequence associated with the i^{th} transmitter, Bₖ⁽ⁱ⁾ is the k^{th} term of the training sequence associated with the i^{th} transmitter, L_{I} is the length of the training sequence and Lₚ is the length of the precomputed channel pulse response.

8. The method of claim 6, wherein the difference metric comprises a metric expressible as:
$${Metric}^{( i )} ( m ) = {\sum }_{k = 1}^{{L}_{I} + {L}_{p}} \vert {A}_{k}^{( i )} ( m ) - {B}_{k}^{( i )} \vert ,$$
where Aₖ⁽ⁱ⁾(m) is the k^{th} term of the precomputed channel signal response with the training sequence associated with the i^{th} transmitter, Bₖ⁽ⁱ⁾ is the k^{th} term of the training sequence associated with the i^{th} transmitter, L_{I} is the length of the training sequence and Lₚ is the length of the precomputed channel pulse response.

9. The method of claim 1, wherein the data sequence is known by the receiver.

10. The method of claim 1, wherein the canceling comprises:
computing a crosstalk noise estimate using the data sequence; and
subtracting the crosstalk noise estimate from the received transmission.

11. The method of claim 10, wherein the computing of the noise estimate is expressible as:
$${Noise\_estimate}_{j}^{( i )} = {\sum }_{k = 0}^{{L}_{p} - 1} {p}_{k}^{( i )} {d}_{j - k}^{( i )} ,$$
where pₖ⁽ⁱ⁾ is the k^{th} term of the precomputed channel pulse response associated with the i^{th} transmitter, dⱼ₋ₖ⁽ⁱ⁾ is the (j-k)th term of the data sequence associated with the i^{th} transmitter, and Lₚ is the length of the precomputed channel pulse response.

12. The method of claim 10, wherein the subtracting of the noise estimate is expressible as:
$$noise\_cancelled {\_sample}_{j} = {r}_{j} - {\sum }_{i = 1}^{N} {n}_{j}^{( i )} ,$$
where rⱼ is the j^{th} noise sample received at the receiver, and
$${\sum }_{i = 1}^{N} {n}_{j}^{( i )}$$
is the noise contribution from the set of communications channels at the receiver.

13. A noise cancellation training system comprising:
a receiver in a communications backplane, the receiver comprising,
an analog-to-digital converter coupled to a signal input, the analog-to-digital converter to digitize a signal provided at the signal input;
a clock/data recovery unit coupled to the analog-to-digital converter, the clock/data recovery unit configured to provide a timing signal to drive the analog-to-digital converter;
a memory coupled to the receiver, the memory to store the digitized signal; and
a metric unit coupled to the memory, the metric unit configured to compute a difference metric between the digitized signal and a plurality of communications channel responses to a known data sequence.

14. The noise cancellation training system of claim 13, wherein the signal comprises the known data sequence.

15. The noise cancellation training system of claim 13, wherein the communications backplane comprises a plurality of receivers, and wherein the memory and the metric unit are shared by each receiver.

16. The noise cancellation training system of claim 13, wherein the plurality of communications channel responses to a known data sequence are precomputed and stored in the memory.

17. A noise cancellation training system comprising:
a memory to store a plurality of communications channel responses to a known data sequence;
a digital-to-analog converter coupled to the memory, the digital-to-analog converter to convert coefficients of the communications channel response into an analog equivalent;
an adder coupled to the digital-to-analog converter and to a signal input, the adder to subtract an analog version of a communications channel response to the known data sequence from a signal provided at the signal input;
an energy detector coupled to an output of the adder, the energy detector configured to compute an average energy in the output of the adder; and
a control logic unit coupled to the energy detector and the memory, the control logic unit configured to select a communications channel response to the known data sequence to provide to the digital-to-analog converter.

18. The noise cancellation training system of claim 17, wherein the signal comprises the known data sequence.

19. The noise cancellation training system of claim 17, wherein the energy detector comprises an average energy detector.

20. The noise cancellation training system of claim 17, wherein the signal is transmitted by a transmitter, and wherein the control logic unit selects every communications channel response to the known data sequence associated with the transmitter to provide to the digital-to-analog converter.
